(19) United States
(12) Patent Application Publication
(10) Pub. No.: US 2017/0325177 A1
(43) Pub. Date: Nov. 9, 2017

(54) METHOD AND COMMUNICATION DEVICE FOR CONTROLLING INTER-LINK INTERFERENCE

(71) Applicant: Telefonaktiebolaget LM Ericsson (publ), Stockholm (SE)

(72) Inventors: Jinhua LIU, Beijing (CN); Virgile GARCIA, Beijing (CN)

(73) Assignee: Telefonaktiebolaget L M Ericsson (publ), Stockholm (SE)

(21) Appl. No.: 15/526,758

(22) PCT Filed: Nov. 14, 2014
(86) PCT No.: PCT/CN2014/091098

§ 371 Date: May 14, 2017

(51) Int. Cl. H04W 52/24; H04W 52/26; H04W 52/38; H04W 52/36

(52) U.S. Cl. CPC H04W 52/243; H04W 52/38; H04W 52/367; H04W 52/265; H04W 52/262

(57) ABSTRACT

A method implemented in a communication device for controlling inter-link interference due to transmissions from the communication device on a radio link to which different types of resources are allocated. The method comprises separately limiting transmission powers on the different types of resources by operating separate interference control instances. At least two of the separate interference control instances are based on the same group of schemes but adopt different scheme-related control parameters for at least one of the schemes or are based on different groups of schemes. The method further comprises performing transmissions on the different types of resources according to the separately limited transmission powers. Also provided is a communication device for controlling inter-link interference.

### TECHNICAL FIELD

The present disclosure generally relates to the technical field of wireless communications, and particularly, to a method implemented in a wireless communication device for controlling inter-link interference as well as the wireless communication device.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

Due to the increasing demand to enhance wireless capacity and due to lack of availability of spectrum in lower frequency range (e.g. 800 MHz-3 GHz), the use of frequencies in 10's of GHz range is being investigated. For the future wireless network, investigations are going on to explore higher frequency bands, for instance, in the range of 30 GHz, 60 GHz and 98 GHz. At this frequency, a very large bandwidth of spectrum is available. This means both operating frequency and bandwidth for the future networks are expected to be much higher than those for legacy wireless.

However, due to large signal attenuation with respect to path loss, the network operating over such high frequencies is supposed to cover small areas with densely deployed radio access nodes (ANs). Considering that such dense deployment is particularly useful to provide sufficient coverage for indoor/hot areas, it has been agreed to exploit Ultra-Density Network (UDN) or Super Dense Network (SDN), which is also referred to as millimeter Wave-Radio Access Technology (mmW-RAT), for the future wireless system.

Currently, it is supposed that the total carrier bandwidth of the mmW-RAT can be up to 1 or 2 GHz. This bandwidth can be composed by a number of sub-band carriers of a certain bandwidth, e.g. 100 MHz. By way of example, FIG. 1 illustrates one mmW-RAT carrier with 4 sub-bands. The smallest resource grid in the figure is an Atomic Scheduling Unit (ASU), which corresponds to a subband in the frequency domain and to a subframe in the time domain.

To allocate the available resources, a contention based resource allocation scheme and/or a scheduling based resource allocation scheme may be applied.

One example of the contention based resource allocation scheme is the well-known IEEE 802.11 standard, wherein a communication device shall firstly send a contention message to make a reservation for some resources before occupying them and the resource reservation is successful if it is accepted by peer communication devices. In such a manner, it can be ensured that resources are dedicatedly occupied by the communication device making the successful reservation. Accordingly, collision between communication devices in resource occupation can be avoided.

In the scheduling based resource allocation scheme, a Central Control Unit (CCU) shared by a cluster of Access Nodes (ANs) is relied on to allocate resources to different radio links. To be specific, the CCU configures, for each of the radio links associated with the ANs, a template frame indicating multiple types of resources allocated to the radio link.

By way of illustration rather than limitation, the resources allocated to a radio link may be classified into dedicated resources, on which data transmission can be performed with high reliability, and non-dedicated resources, on which data transmission of lower reliability can be performed to achieve enhanced data rate. If a radio link is allocated with dedicated resources, the radio link will have the highest priority to access these resources while any other radio link shall control its interference to the radio link on the allocated dedicated resources. On the other hand, if a radio link is allocated with non-dedicated resources, both the radio link and other radio links can access these resources and the use of these resources by one of the radio links may produce interference to the others.

For illustration, an exemplary radio network where the scheduling based resource allocation scheme may be implemented is depicted in FIG. 2. In addition to AN1-AN4, the network comprises a CCU responsible to determine, for radio link 1, a template frame based on relevant measurements and/or data rate requests from peer communication devices (i.e., AN1 and User Equipment 1 (UE1)) on radio link 1. Further, the template frame determined for radio link 1 can be updated by the CCU during a communication session according to various varying factors, such as interference measurements and/or data rate requests from radio link 2 which is the neighboring link of radio link 1. Likewise, the CCU determines a template frame for radio link 2 and updates the template frame by taking into account radio link 1's impact on radio link 2.

Further details of the template frames configured for radio links 1 and 2 are given in FIG. 3. As illustrated, each of the template frames specifies, for its associated radio link whose number is given in the colored ASUs, both dedicated resources (shown as dark-colored ASUs) and non-dedicated resources (shown as light-colored ASUs).

Instead of being applied separately, the contention based resource allocation scheme and the scheduling based resource allocation scheme may be applied jointly (for example, in a time division manner) as illustrated in FIG. 4. Accordingly, contention-based resources may be allocated to a radio link, in addition to the dedicated and non-dedicated resources.

Referring back to FIG. 3, the scheduling based resource allocation scheme allows certain ASUs to be allocated to radio link 1 as dedicated resources and meanwhile allocated to radio link 2 as non-dedicated resources. Such reuse of resources by neighboring links 1 and 2 may cause undesirable inter-link interference. Specifically, transmissions on the circled dedicated resources associated with radio link 1 may cause inter-link interference to transmissions on the circled non-dedicated resources associated with radio link 2 and vice versa.

### SUMMARY

In view of the foregoing, an object of the present disclosure is to control inter-link interference in a wireless network where each radio link can be allocated with different types of resources.

To achieve this object, according to a first aspect of the present disclosure, there is provided a method implemented in a communication device for controlling inter-link interference due to transmissions from the communication device on a radio link to which different types of resources are allocated. The method comprises separately limiting transmission powers on the different types of resources by operating separate interference control instances. At least two of the separate interference control instances are based on the same group of schemes but adopt different scheme-related control parameters for at least one of the schemes or are based on different groups of schemes. The method further comprises performing transmissions on the different types of resources according to the separately limited transmission powers.

According to a second aspect of the present disclosure, there is provided a communication device for controlling inter-link interference due to transmissions from the communication device on a radio link to which different types of resources are allocated. The communication device comprises a transmission power limitation section and a transmission section. The transmission power limitation section is configured to separately limit transmission powers on the different types of resources by operating separate interference scheme instances.

At least two of the separate interference control instances are based on the same group of schemes but adopt different scheme-related control parameters for at least one of the schemes or are based on different groups of schemes. The transmission section is configured to perform transmissions on the different types of resources according to the separately limited transmission powers.

By operating separate interference instances to separately limit transmission powers on different types of resources and performing transmissions on the resources according to the separately limited transmission powers, resource type specific inter-link interference control can be achieved. This advantageously allows distinguishing characteristics between the different types of resources (such as different reliabilities of transmissions on the dedicated resources and the non-dedicated resources) to be considered in the inter-link interference control.

As an additional object of the present disclosure, parameter adaptation is to be performed for facilitating resource type specific inter-link interference control.

To achieve this object, according to a third aspect of the present disclosure, there is provided a method implemented in a CCU for managing a control parameter that is used by an interference control instance particularly operated for non-dedicated resources allocated to a radio link to limit transmission powers on the non-dedicated resources. The method comprises receiving, from a communication device performing reception on another radio link, a measurement report indicating whether or not interference due to transmissions on the non-dedicated resources that is suffered by dedicated resources allocated to the other radio link is higher than a first threshold and/or lower than a second threshold. The first threshold is higher than the second threshold. The method further comprises adjusting the control parameter based on the received measurement report.

According to a fourth aspect of the present disclosure, there is provided a CCU for managing a control parameter that is used by an interference control instance particularly operated for non-dedicated resources allocated to a radio link to limit transmission powers on the non-dedicated resources. The CCU comprises a reception section and a parameter adjustment section. The reception section is configured to receive, from a communication device performing reception on another radio link, a measurement report indicating whether or not interference due to transmissions on the non-dedicated resources that is suffered by dedicated resources allocated to the other radio link is higher than a first threshold and/or lower than a second threshold. The first threshold is higher than the second threshold. The parameter adjustment section is configured to adjust the control parameter based on the received measurement report.

By adjusting the control parameter for the non-dedicated resources allocated to the radio link based on the measurement report for the dedicated resources allocated to the other radio link, the transmission powers on the non-dedicated resources can be adaptively controlled by taking into account the interference that is suffered by the dedicated resources due to transmissions on the non-dedicated resources.

According to a fifth aspect of the present disclosure, there is provided a communication device for controlling inter-link interference due to transmissions from the communication device on a radio link to which different types of resources are allocated. The communication device comprises a processor and a memory. The memory has machine-readable program code stored therein. When executed by the processor, the program code causes the communication device to perform the method according to the first aspect of the present disclosure.

According to a sixth aspect of the present disclosure, there is provided a CCU for managing a control parameter that is used by an interference control instance particularly operated for non-dedicated resources allocated to a radio link to limit transmission powers on the non-dedicated resources. The CCU comprises a processor and a memory. The memory has machine-readable program code stored therein. When executed by the processor, the program code causes the CCU to perform the method according to the third aspect of the present disclosure.

### BRIEF DESCRIPTION OF THE DRAWINGS

The above and other objects, features, and advantages of the present disclosure will become apparent from the following descriptions on embodiments of the present disclosure with reference to the drawings, in which:

FIG. 1 is a diagram conceptually illustrating a mmW-RAT carrier and associated subbands, subframes and ASUs;

FIG. 2 is a diagram schematically illustrating an exemplary network where a scheduling based resource allocation scheme may be implemented;

FIG. 3 is diagram schematically illustrating a template frame for each of radio links 1 and 2 in FIG. 2;

FIG. 4 is diagram schematically illustrating an exemplary time-division implementation of a contention based resource allocation scheme and a scheduling based resource allocation scheme;

FIG. 5 is a flowchart illustrating a method embodiment implemented in a communication device for controlling inter-link interference according to the present disclosure;

FIG. 6 is a flowchart illustrating operations of a method step shown in FIG. 5;

FIG. 7 is a diagram schematically illustrating an exemplary scenario of operating separate interference control instances for dedicated and non-dedicated resources, wherein the interference control instances are based on a CLPC scheme but adopt different quality limits;

FIG. 8 is a flowchart illustrating a method embodiment implemented in a CCU for managing a control parameter, which is used for resource type specific inter-link interference control, according to the present disclosure;

FIG. 9 is a flowchart illustrating operations of a method step shown in FIG. 8;

FIG. 10 is a block diagram illustrating an exemplary structure of a communication device according to the present disclosure; and

FIG. 11 is a block diagram illustrating an exemplary structure of a CCU according to the present disclosure.

### DETAILED DESCRIPTION OF EMBODIMENTS

In the discussion that follows, specific details of particular embodiments of the present techniques are set forth for purposes of explanation and not limitation. It will be appreciated by those skilled in the art that other embodiments may be employed apart from these specific details. Furthermore, in some instances detailed descriptions of well-known methods, nodes, interfaces, circuits, and devices are omitted so as not to obscure the description with unnecessary detail. Those skilled in the art will appreciate that the functions described may be implemented in one or in several nodes. Some or all of the functions described may be implemented using hardware circuitry, such as analog and/or discrete logic gates interconnected to perform a specialized function, Application Specific Integrated Circuits (ASICs), Programmable Logical Arrays (PLAs), etc. Likewise, some or all of the functions may be implemented using software programs and data in conjunction with one or more digital microprocessors or general purpose computers. Where nodes that communicate using the air interface are described, it will be appreciated that those nodes also have suitable radio communications circuitry. Moreover, the technology can additionally be considered to be embodied entirely within any form of computer-readable memory, including non-transitory embodiments such as solid-state memory, magnetic disk, or optical disk containing an appropriate set of computer instructions that would cause a processor to carry out the techniques described herein.

Hardware implementations of the presently disclosed techniques may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

Note that although terminology commonly used to describe mmW-RAT technology is used in this disclosure to exemplify the embodiments, this should not be seen as limiting the scope of the techniques to only the aforementioned system. Other wireless systems may also benefit from exploiting the ideas covered within this disclosure, as long as a radio link in the wireless systems may be allocated with different types of resources.

As the inventors of the present application notice, it is often not optimal to control inter-link interference due to transmissions on a radio link by uniformly limiting transmission powers on all resources allocated to the radio link in case the resources may be classified into different types according to their characteristics.

Taking a wireless system based on the mmW-RAT technology as an example, if transmission powers on dedicated and non-dedicated resources allocated to a radio link are uniformly limited to guarantee high reliability of transmissions on the dedicated resources, the transmission powers on the non-dedicated resources may cause too high interference significantly degrading performance of transmissions on a neighboring radio link. This is undesirable especially when the non-dedicated resources overlap with dedicated resources allocated to the neighboring radio link. On the other hand, if transmission powers on the dedicated and non-dedicated resources are uniformly limited to avoid too high inter-link interference due to transmissions on the non-dedicated resources, the transmission powers on the dedicated resources may be inadequate to provide sufficient transmission reliability.

To avoid or at least alleviate such undesirable effects, a resource type specific inter-link interference control method is proposed here.

FIG. 5 schematically illustrates such a method 500 implemented in a communication device for controlling inter-link interference due to transmissions from the communication device on a radio link, to which different types of resources are allocated.

As illustrated, after a trigger of the method, for example the controlling function has been enabled, or the scheduled timer reminds to switch to the controlling mode, transmission powers on different types of resources are separately limited by operating separate interference control instances at step s510. At least two of the separate interference control instances are based on the same group of schemes but adopt different scheme-related control parameters or are based on different groups of schemes.

By way of illustration rather than limitation, the group of schemes may comprise a Closed Loop Power Control (CLPC) scheme and the scheme-related control parameter may include a quality limit, for example, taking the form of a Signal to Interference plus Noise Ratio (SINR) limit, a Signal to Noise Ratio (SNR) limit, a received signal strength limit, or a received power density limit.

In case one of the interference control instances is based on the CLPC scheme and adopt the quality limit, a Transmission Power Control (TPC) command may be generated subject to the quality limit, at a peer communication device performing reception on the radio link, according to quality measurements for transmissions from the communication device to the peer communication device on the corresponding type of resources. By way of example, a TPC DOWN command may be generated if the measured quality exceeds the quality limit.

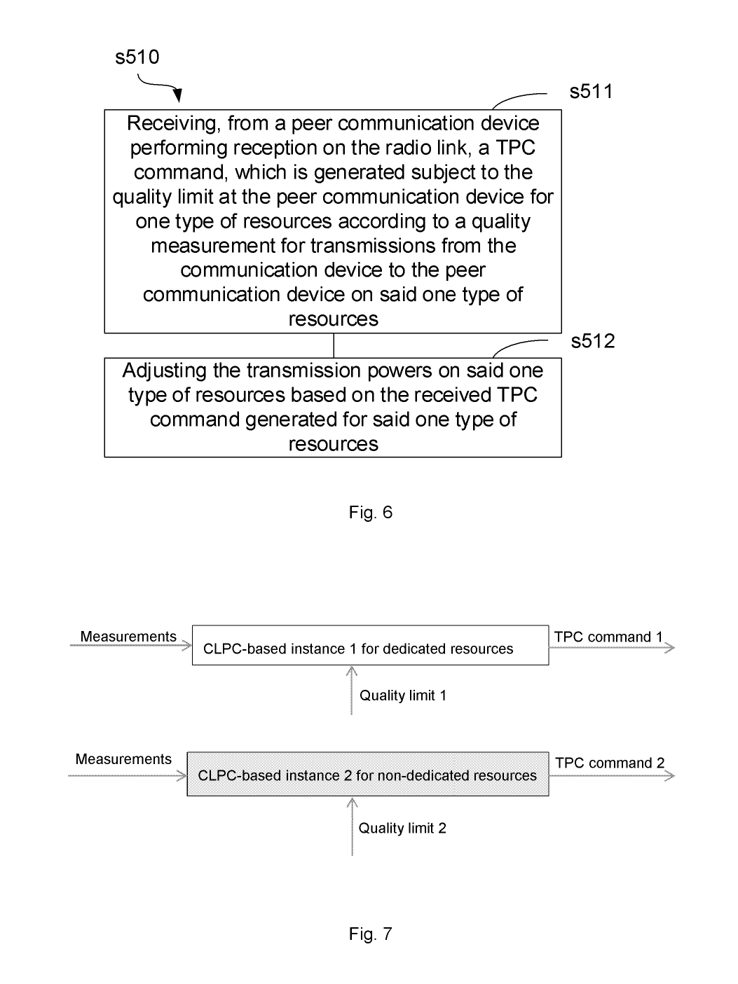

Accordingly, the step s510 may comprise substeps s511 and s512 as illustrated in FIG. 6. At substep s511, the TPC command may be received from the peer communication device. At substep s512, the transmission powers on the corresponding type of resources may be adjusted based on the received TPC command.

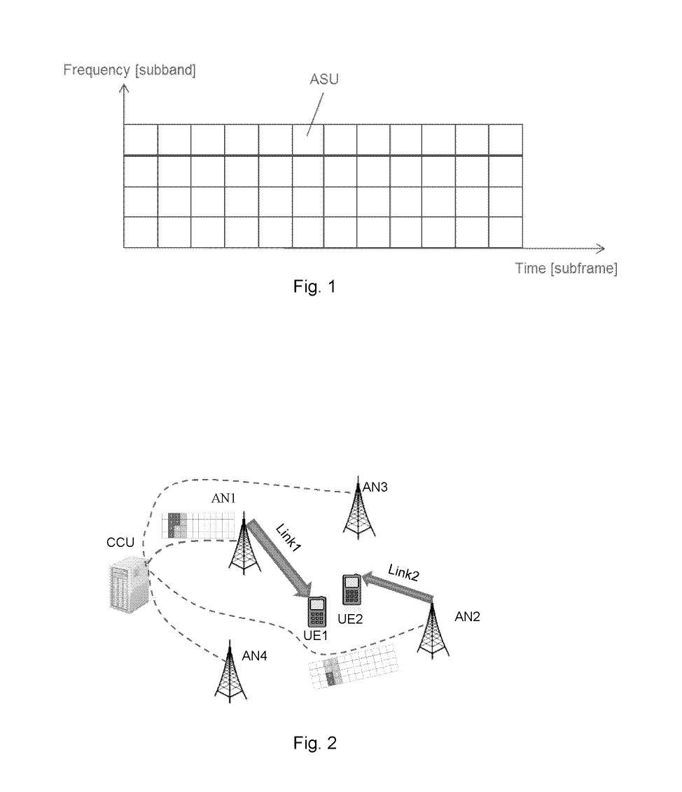

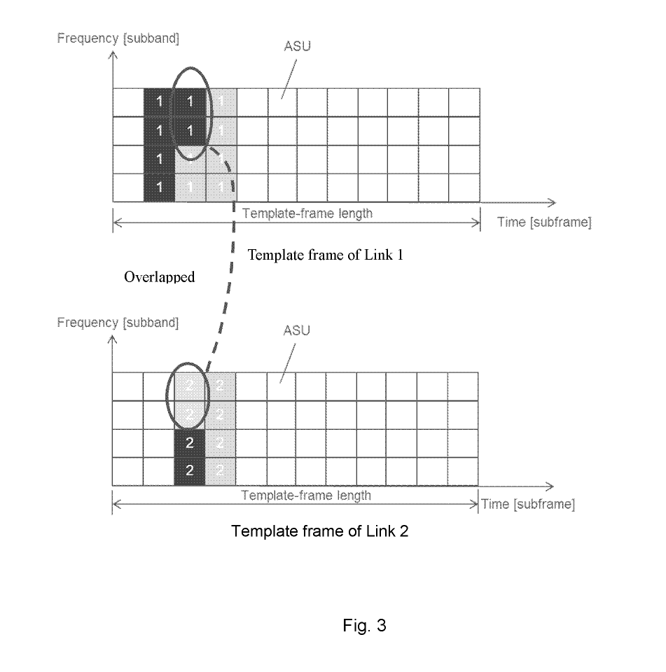

Note that the communication device where the method 500 is implemented may be an AN (e.g., AN1 in FIG. 2) and accordingly its peer communication device may be a terminal device (e.g., UE1 in FIG. 2). Alternatively, the communication device may be a terminal device and its peer communication device may be an AN. In the former case, the terminal device may generate a TPC command based on quality measurement for DL transmission from the AN to the terminal device and send the TPC command to the AN. In the latter case, the AN may generate a TPC command based on quality measurement for UL transmission from the terminal device to the AN and send the TPC command to the terminal device.

To accelerate the reduction of transmission powers in case the quality limit has been far exceeded, the quality range above the quality limit may be divided into multiple (e.g., two) ranges for which different down step sizes are applied respectively. Specifically, if the measured quality falls in the lower range, the transmission power may be reduced by a first down step size. If the measured quality falls in the higher range, the transmission power may be reduced by a second down step size larger than the first down step size.

In practical implementation, the first and/or second down step sizes used by one interference control instance may be different from the first and/or second down step sizes used by another interference control instance based on the CLPC scheme.

In case the different types of resources comprise dedicated and non-dedicated resources, two interference control instances based on the CLPC scheme but adopting different quality limits may be separately operated for the dedicated and non-dedicated resources as illustrated in FIG. 7. Because reliable transmissions are required for the dedicated resources, the quality limit adopted for the dedicated resources is supposed to be higher than the quality limit adopted for the non-dedicated resources.

In addition to or instead of the CLPC scheme, the group of schemes may comprise a transmission power limitation scheme, for which the scheme-related control parameter may include a maximum allowable transmission power. In case two interference control instances based on the transmission power limitation scheme are separately operated for the dedicated and non-dedicated resources, the maximum allowable transmission power adopted for the dedicated resources is supposed to be higher than the maximum allowable transmission power adopted for the non-dedicated resources.

Additionally or alternatively, the group of schemes may comprise a Modulation and Coding Scheme (MCS) level limitation scheme for which the scheme-related control parameter may include a maximum allowable MCS level, if the transmission power is adapted based on the applied MCS level and a higher MCS level defines a higher upper limit for the transmission power.

In case two interference control instances based on the MCS level limitation scheme are separately operated for the dedicated and non-dedicated resources, the maximum allowable MCS level adopted for the dedicated resources is supposed to be higher than the maximum allowable MCS level adopted for the non-dedicated resources.

In practical implementation, an interference control instance operated for one type of resources may be split into sub-instances, in case different resource units of the same type of resources may be further divided into different resource sub-groups and different resource sub-group has different interference requirements. For example, by applying different CLPC-based sub-instances with different quality limits respectively, inter-link interference can be further controlled respectively with respect to the different resource sub-groups.

In another aspect, a CLPC-based instance (CLPC 1) that controls the interference within a configured interference limit for a resource type may be operated in cooperation with a possible CLPC-based instance (CLPC 2) that controls the radio quality to approach a certain predefined radio quality target guaranteeing a Quality of Service (QoS) for the same resource type. By way of example, when the resulting interference is lower than the interference limit indicated by the predefined quality target, the TPC is generated by CLPC 2, that is, either TPC UP or DOWN command can be possibly generated to approach the predefined quality target. Otherwise, when the resulting interference is higher than the interference limit indicated by the corresponding quality target, only TPC DOWN is generated.

In a further aspect, an interference control instance operated for one type of resources may be based on any combination of the CLPC, transmission power limitation and MCS level limitation schemes. By way of example, in case both the CLPC scheme and the transmission power limitation scheme are used to control interference for certain resource type and the required transmission power on the resource type after adjustment according to the received TPC command exceeds the maximum allowable transmit power, the transmission power is scaled to the maximum allowable transmission power. If the required transmission power on the resource type is under the transmission power limit after adjustment according to the received TPC command, no power scaling is performed. In addition, the MCS for a resource type may be selected within the limit of the configured threshold of MCS level.

As an example of the at least two of the separate interference control instances being based on different groups of schemes, one of the at least two instances may be based on both the CLPC scheme and the transmission power limitation scheme while another one of at least two instances may be based on any other combination of the CLPC, transmission power limitation and MCS level limitation schemes, such as based on both the CLPC scheme and the MCS level limitation scheme.

Referring back to FIG. 5, after step s510, it proceeds to step s520, where transmissions are performed on the different types of resources according to the separately limited transmission powers. Then, the method is terminated.

By operating separate interference instances to separately limit transmission powers on different types of resources and performing transmissions on the resources according to the separately limited transmission powers, resource type specific inter-link interference control can be achieved. This advantageously allows distinguishing characteristics between the different types of resources (such as different reliabilities of transmissions on the dedicated resources and the non-dedicated resources) to be considered in the inter-link interference control.

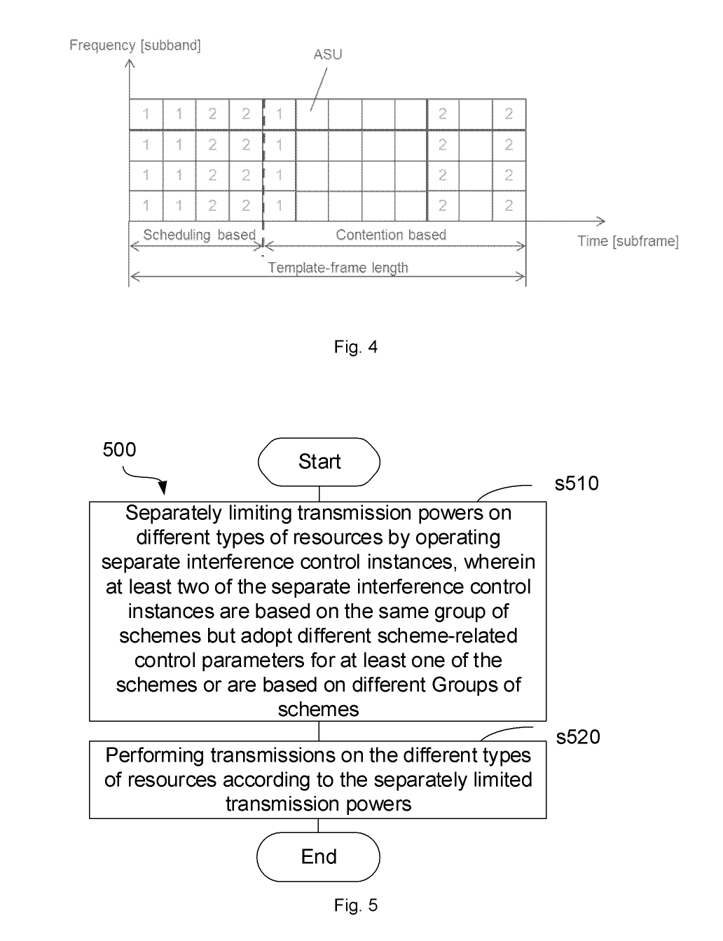

It shall be noted that, in addition to or instead of the dedicated and non-dedicated resources set forth in the above embodiments for illustration only, the inventive concept of resource type specific inter-link interference control may be applied to other types of resources (such as contention-based ASUs illustrated in FIG. 4). In practical implementation, one of the interference control instances operated for the other types of resources may be based on the same group of schemes and adopt the same scheme-related control parameters as either the instance operated for the dedicated resources or the instance operated for the non-dedicated resources.

To facilitate the above-described resource type specific inter-link interference control, a parameter adaptation method is accordingly proposed here.

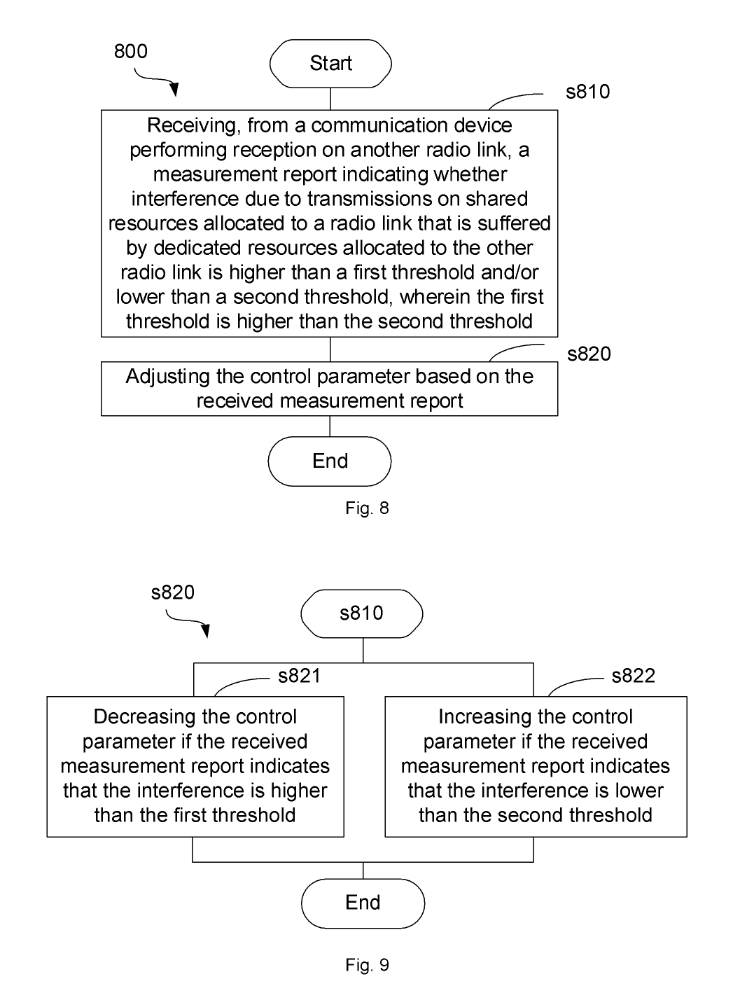

FIG. 8 schematically illustrates such a method 800 implemented in a CCU for managing a control parameter that is used by an interference control instance particularly operated for non-dedicated resources allocated to a radio link to limit transmission powers on the non-dedicated resources. In practice, the CCU may a logical node located between a core network and the ANs. One CCU may be responsible to manage the parameter configuration and the coordination of a group of ANs. The CCU may be physically located in a separate unit from the ANs and the core network, co-located with a certain AN, or co-located with a local gateway for the group of ANs.

As illustrated, after a trigger of the method, for example the controlling function has been enabled, or the scheduled timer reminds to switch to the controlling mode, a measurement report is received from a communication device performing reception on another radio link at step s810. The measurement report may indicate whether or not interference due to transmissions on the non-dedicated resources that is suffered by dedicated resources allocated to the other radio link is higher than a first threshold. Additionally or alternatively, the measurement report may indicate whether or not the interference is lower than a second threshold smaller than the first threshold.

Then, based on the received measurement report, the control parameter is adjusted at step 820. After that, the method is terminated.

By adjusting the control parameter for the non-dedicated resources allocated to the radio link based on the measurement report for the dedicated resources allocated to the other radio link, the transmission powers on the non-dedicated resources can be adaptively controlled by taking into account the interference that the dedicated resources suffers due to transmissions on the non-dedicated resources.

As set forth above with respect to method 500, the interference control instance may be based on at least one of a CLPC scheme for which the control parameter includes a quality limit, a transmission power limitation scheme for which the control parameter includes a maximum allowable transmission power and an MCS level limitation scheme for which the control parameter includes a maximum allowable MCS level.

In practical implementation, the schemes and their related control parameters may be predefined or semi-statically set for a radio link via Operation and Maintenance (O&M) interfaces and distributed to network nodes via either a broadcasting message or a dedicated control message. Also, reconfiguration of the schemes and related control parameters may be performed whenever the template frame for the radio link is updated by the CCU. In that case, the reconfigured schemes and parameters can be sent to peer communication devices on the radio link in addition to the updated template frame.

In an embodiment, the step 820 may comprise substeps s821 and s822. At substep s821, the control parameter is decreased if the received measurement report indicates that the interference is higher than the first threshold. As such, the transmission power on the non-dedicated resources will be limited in case it causes so strong interference as to intolerably affect the transmission reliability on the dedicated resources.

At substep s822, the control parameter is increased if the received measurement report indicates that the interference is lower than the second threshold. As such, the transmission power on the non-dedicated resources will be increased to support an enhanced data rate in case the resulting interference to the transmission reliability on the dedicated resources is still low.

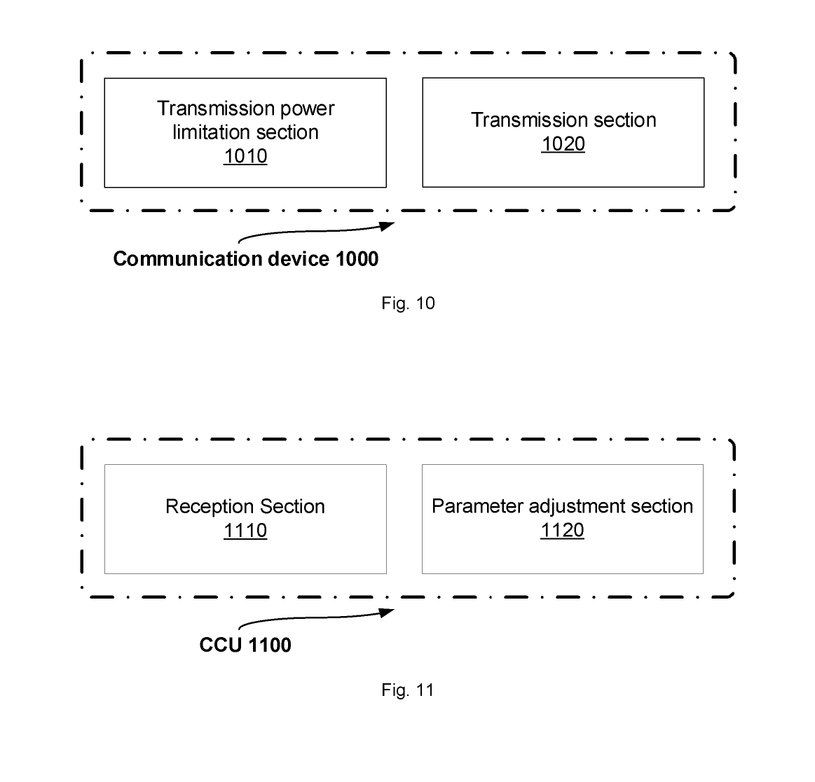

In the following, structures of a communication device 1000 and a CCU 1100 according to the present disclosure will be given with reference to FIGS. 10-11. The communication device 1000 is provided for controlling inter-link interference due to transmissions from the communication device on a radio link to which different types of resources are allocated. The CCU 1100 is provided for managing a control parameter that is used by an interference control instance particularly operated for non-dedicated resources allocated to a radio link to limit transmission powers on the non-dedicated resources.

As shown in FIG. 10, the communication device 1000 comprises a transmission power limitation section 1010 and a transmission section 1020. The transmission power limitation section 1010 is configured to separately limit transmission powers on the different types of resources by operating separate interference scheme instances. At least two of the separate interference control instances are based on the same group of schemes but adopt different scheme-related control parameters for at least one of the schemes or are based on different groups of schemes. The transmission section 1020 is configured to perform transmissions on the different types of resources according to the separately limited transmission powers.

As mentioned above, the communication device 1000 may be either an AN or a terminal device.

In an embodiment, the group of schemes may comprise at least one of a CLPC scheme, a transmission power limitation scheme and an MCS level limitation scheme. For the CLPC scheme, the scheme-related control parameter may include a quality limit. For the transmission power limitation scheme, the scheme-related control parameter may include a maximum allowable transmission power. For the MCS level limitation scheme, the scheme-related control parameter may include a maximum allowable MCS level.

In an embodiment, the quality limit may be an SINR limit, an SNR limit, a received signal strength limit or a received power density limit.

In an embodiment, in case one of said separate interference control instances is based on the CLPC scheme and adopts the quality limit, the transmission power limitation section 1010 may be configured to, for said CLPC scheme, adjust the transmission powers on one type of resources based on a TPC command received from a peer communication device performing reception on the radio link, wherein the TPC command is generated subject to the quality limit, at the peer communication device for said one type of resources according to a quality measurement for transmissions from the communication device to the peer communication device on said one type of resources.

In an embodiment, if the received TPC command is a TPC DOWN command, the transmission power limitation section 1010 may be configured to reduce the transmission power on said one type of resources by a first down step size in case the quality measurement for the transmissions on said one type of resources falls in a first range and to reduce the transmission power on said one type of resources by a second down step size in case the quality measurement for the transmissions on said one type of resources falls in a second range. The first down step size is smaller than the second down step size and the first range is lower than the second range.

In an embodiment, the first and/or second down step sizes used by said one interference control instance may be different from the first and/or second down step sizes used by another interference control instance based on the CLPC scheme.

In an embodiment, the different types of resources may comprise dedicated resources and non-dedicated resources. Said at least two of the separate interference control instances may be respectively operated for the dedicated resources and the non-dedicated resources and be based on the same scheme but adopt different scheme-related control parameters. The quality limit adopted for the dedicated resources may be higher than the quality limit adopted for the non-dedicated resources. The maximum allowable transmission power adopted for the dedicated resources may be higher than the maximum allowable transmission power adopted for the non-dedicated resources. The maximum allowable MCS level adopted for the dedicated resources may be higher than the maximum allowable MCS level adopted for the non-dedicated resources.

As those skilled in the art will appreciate, the above-described sections may be implemented separately as suitable dedicated circuits. Nevertheless, these sections can also be implemented using any number of dedicated circuits through functional combination or separation. In some embodiments, these sections may be even combined in a single application specific integrated circuit (ASIC).

As an alternative software-based implementation, the communication device may comprise a transceiver, a memory and a processor (including but not limited to a microprocessor, a microcontroller or a Digital Signal Processor (DSP), etc.) The memory stores machine-readable program code executable by the processor. The processor, when executing the machine-readable program code, performs the function of the above-described transmission power limitation section and controls the transceiver to perform the function of the above-described transmission section.

Referring then to FIG. 11, the CCU 1100 comprises a reception section 1110 and a parameter adjustment section 1120. The reception section 1110 is configured to receive, from a communication device performing reception on another radio link, a measurement report indicating whether or not interference due to transmissions on the non-dedicated resources that is suffered by dedicated resources allocated to the other radio link is higher than a first threshold and/or lower than a second threshold. The first threshold is higher than the second threshold. The parameter adjustment section 1120 is configured to adjust the control parameter based on the received measurement report.

In an embodiment, the interference control instance may be based on at least one of a CLPC scheme for which the control parameter includes a quality limit, a transmission power limitation scheme for which the control parameter includes a maximum allowable transmission power and an MCS level limitation scheme for which the control parameter includes a maximum allowable MCS level.

In an embodiment, the adjustment section 1120 may be configured to decrease the control parameter if the received measurement report indicates that the interference is higher than the first threshold and/or increase the control parameter if the received measurement report indicates that the interference is lower than the second threshold.

As those skilled in the art will appreciate, the above-described sections may be implemented separately as suitable dedicated circuits. Nevertheless, these sections can also be implemented using any number of dedicated circuits through functional combination or separation. In some embodiments, these sections may be even combined in a single application specific integrated circuit (ASIC).

As an alternative software-based implementation, the CCU may comprise a transceiver, a memory and a processor (including but not limited to a microprocessor, a microcontroller or a Digital Signal Processor (DSP), etc.) The memory stores machine-readable program code executable by the processor. The processor, when executing the machine-readable program code, controls the transceiver to perform function of the above-described reception section and performs the function of the above-described parameter adjustment section.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

1. A method implemented in a communication device for controlling inter-link interference due to transmissions from the communication device on a radio link to which different types of resources are allocated, the method comprising:
separately limiting transmission powers on the different types of resources by operating separate interference control instances, wherein at least two of the separate interference control instances are based on the same group of schemes, but adopt different scheme-related control parameters for at least one of the schemes, or based on different groups of schemes; and
performing transmissions on the different types of resources according to the separately limited transmission powers.

2. The method of claim 1, wherein a group of schemes for the same group of schemes or the different groups of schemes comprises at least one of:
a Closed Loop Power Control (CLPC) scheme, for which the scheme-related control parameter includes a quality limit;
a transmission power limitation scheme, for which the scheme-related control parameter includes a maximum allowable transmission power; and
a Modulation and Coding Scheme (MCS) level limitation scheme, for which the scheme-related control parameter includes a maximum allowable MCS level.

3. The method of claim 2, wherein the quality limit is a Signal to Interference plus Noise Ratio (SINR) limit, a Signal to Noise Ratio (SNR) limit, a received signal strength limit or a received power density limit.

4. The method of claim 2, wherein, in case one of said separate interference control instances is based on the CLPC scheme and adopts the quality limit, the separately limiting transmission powers on the different types of resources by operating separate interference control instances comprises: for said CLPC scheme,
receiving, from a peer communication device performing reception on the radio link, a Transmission Power Control (TPC) command, which is generated subject to the quality limit at the peer communication device for one type of resources according to a quality measurement for transmissions from the communication device to the peer communication device on said one type of resources; and
adjusting the transmission powers on said one type of resources based on the received TPC command generated for said one type of resources.

5. The method of claim 4, wherein if the received TPC command is a TPC DOWN command,
the transmission power on said one type of resources is reduced by a first down step size in case the quality measurement for the transmissions on said one type of resources falls in a first range; and
the transmission power on said one type of resources is reduced by a second down step size in case the quality measurement for the transmissions on said one type of resources falls in a second range, wherein the first down step size is smaller than the second down step size and the first range is lower than the second range.

6. The method of claim 5, wherein at least one of the first and second down step sizes used by said one interference control instance is different from at least one of the first and second down step sizes used by another interference control instance based on the CLPC scheme.

7. The method of claim 4, wherein the different types of resources comprise dedicated resources and non-dedicated resources, and said at least two of the separate interference control instances are respectively operated for the dedicated resources and the non-dedicated resources and are based on the same scheme but adopt different scheme-related control parameters, and wherein
the quality limit adopted for the dedicated resources is higher than the quality limit adopted for the non-dedicated resources;
the maximum allowable transmission power adopted for the dedicated resources is higher than the maximum allowable transmission power adopted for the non-dedicated resources; and
the maximum allowable MCS level adopted for the dedicated resources is higher than the maximum allowable MCS level adopted for the non-dedicated resources.

8. A method implemented in a Central Control Unit (CCU) for managing a control parameter that is used by an interference control instance particularly operated for non-dedicated resources allocated to a radio link to limit transmission powers on the non-dedicated resources, the method comprising:
receiving, from a communication device performing reception on another radio link, a measurement report indicating whether or not interference due to transmissions on the non-dedicated resources that is suffered by dedicated resources allocated to the other radio link is higher than a first threshold or lower than a second threshold, wherein the first threshold is higher than the second threshold; and
adjusting the control parameter based on the received measurement report.

9. The method of claim 8, wherein the interference control instance is based on at least one of a Closed Loop Power Control (CLPC) scheme for which the control parameter includes a quality limit, a transmission power limitation scheme for which the control parameter includes a maximum allowable transmission power and a Modulation and Coding Scheme (MCS) level limitation scheme for which the control parameter includes a maximum allowable MCS level.

10. The method of claim 9, wherein the adjusting the control parameter based on the received measurement report comprises at least one of:
decreasing the control parameter if the received measurement report indicates that the interference is higher than the first threshold; and
increasing the control parameter if the received measurement report indicates that the interference is lower than the second threshold.

11. A communication device for controlling inter-link interference due to transmissions from the communication device on a radio link to which different types of resources are allocated, the communication device comprising:
a transmission power limitation section configured to separately limit transmission powers on the different types of resources by operating separate interference control instances, wherein at least two of the separate interference control instances are based on the same group of schemes, but adopt different scheme-related control parameters for at least one of the schemes, or based on different groups of schemes; and
a transmission section configured to perform transmissions on the different types of resources according to the separately limited transmission powers.

12. The communication device of claim 11, wherein a group of schemes for the same group of schemes or the different groups of schemes comprises at least one of:
a Closed Loop Power Control (CLPC) scheme, for which the scheme-related control parameter includes a quality limit;
a transmission power limitation scheme, for which the scheme-related control parameter includes a maximum allowable transmission power; and
a Modulation and Coding Scheme (MCS) level limitation scheme, for which the scheme-related control parameter includes a maximum allowable MCS level.

13. The communication device of claim 12, wherein the quality limit is a Signal to Interference plus Noise Ratio (SINR) limit, a Signal to Noise Ratio (SNR) limit, a received signal strength limit or a received power density limit.

14. The communication device of claim 12, wherein, in case one of said separate interference control instances is based on the CLPC scheme and adopts the quality limit, the transmission power limitation section is configured to, for said CLPC scheme, adjust the transmission powers on one type of resources based on a TPC command received from a peer communication device performing reception on the radio link, wherein the TPC command is generated subject to the quality limit, at the peer communication device for said one type of resources according to a quality measurement for transmissions from the communication device to the peer communication device on said one type of resources.

15. The communication device of claim 14, wherein, if the received TPC command is a TPC DOWN command, the transmission power limitation section is configured to reduce the transmission power on said one type of resources by a first down step size in case the quality measurement for the transmissions on said one type of resources falls in a first range and to reduce the transmission power on said one type of resources by a second down step size in case the quality measurement for the transmissions on said one type of resources falls in a second range, wherein the first down step size is smaller than the second down step size and the first range is lower than the second range.

16. The communication device of claim 15, wherein at least one of the first and second down step sizes used by said one interference control instance is different from at least one of the first and second down step sizes used by another interference control instance based on the CLPC scheme.

17. The communication device of claim 14, wherein the different types of resources comprise dedicated resources and non-dedicated resources, and said at least two of the separate interference control instances are respectively operated for the dedicated resources and the non-dedicated resources and are based on the same scheme but adopt different scheme-related control parameters, and wherein
the quality limit adopted for the dedicated resources is higher than the quality limit adopted for the non-dedicated resources;
the maximum allowable transmission power adopted for the dedicated resources is higher than the maximum allowable transmission power adopted for the non-dedicated resources; and
the maximum allowable MCS level adopted for the dedicated resources is higher than the maximum allowable MCS level adopted for the non-dedicated resources.

18. A Central Control Unit (CCU) for managing a control parameter that is used by an interference control instance particularly operated for non-dedicated resources allocated to a radio link to limit transmission powers on the non-dedicated resources, the CCU comprising:
a reception section configured to receive, from a communication device performing reception on another radio link, a measurement report indicating whether or not interference due to transmissions on the non-dedicated resources that is suffered by dedicated resources allocated to the other radio link is higher than a first threshold or lower than a second threshold, wherein the first threshold is higher than the second threshold; and
a parameter adjustment section configured to adjust the control parameter based on the received measurement report.

19. The CCU of claim 18, wherein the interference control instance is based on at least one of a Closed Loop Power Control (CLPC) scheme for which the control parameter includes a quality limit, a transmission power limitation scheme for which the control parameter includes a maximum allowable transmission power, and a Modulation and Coding Scheme (MCS) level limitation scheme for which the control parameter includes a maximum allowable MCS level.

20. The CCU of claim 19, wherein the adjustment section is configured to
decrease the control parameter if the received measurement report indicates that the interference is higher than the first threshold; and
increase the control parameter if the received measurement report indicates that the interference is lower than the second threshold.
